(19) United States
(12) Patent Application Publication
(10) Pub. No.: US 2007/0204179 A1
(43) Pub. Date: Aug. 30, 2007

(54) Minimize Energy Consumption Using Optimal Voltage Assignment Algorithm

(76) Inventors: Meikang Qiu, Richardson, TX (US); Edwin H.M. Sha, Richardson, TX (US); Chun Jason Xue, Richardson, TX (US); Qingfeng Zhuge, Richardson, TX (US)

Correspondence Address: Meikang Qiu, 2200 Waterview Parkway Aot.#25309, Richardson, TX, 75080, US

(21) Appl. No.: 11/307,924

(22) Filed: Feb. 28, 2006

(51) Int. Cl. G06F 1/32

(52) U.S. Cl. 713/320

(57) ABSTRACT

Low energy consumptions are extremely important in real-time embedded systems. Due to the uncertainties in execution time of some tasks, this paper models each varied execution time as a probabilistic random variable and incorporating applications' performance requirements to explore real-time embedded systems and avoid over-designing them. We propose a practical algorithm to minimize the expected value of total energy consumption while satisfying the timing constraint with a guaranteed confidence probability. The experimental results show that our approach achieves significant energy saving than previous work. For example, our algorithm achieves an average improvement of 61.2% on total energy consumption compared with the algorithm in previous work.

### BACKGROUND OF THE INVENTION

Embedded systems, such as battery-operated PDAs, mobile phones, etc., are everywhere in our daily lives. Many of these systems can tolerate occasional deadline misses and some tasks in them may not have fixed execution time. Such tasks usually contain conditional instructions and/or operations that could have different execution times for different inputs. It is possible to obtain the execution time distribution for each task by sampling or profiling. Prior approaches for hardware/software co-design of embedded systems guarantee no deadline missing by considering worst-case execution time of each task. These approaches are pessimistic and only suitable for hard real-time systems, where any deadline miss will be catastrophic. They are not suitable for soft real-time systems, which can tolerate occasional violations of timing constraints. Using probabilistic approach, we can deliver higher performance with less energy consumption. Our probabilistic approach can be applied to both hard real-time systems and soft real-time systems. Hard real-time is a special case when the probability equals one. Dynamic voltage scaling (DVS) is one of the most effective techniques to reduce energy consumption. We use probabilistic approach and DVS to avoid over-designing systems.

We propose a novel optimal algorithm, VAP_Opt, to minimize expected value of total energy consumption while satisfying timing constraints with guaranteed probabilities for real-time applications. We prove our algorithm gives voltage assignment with the minimum energy consumption. We conduct experiments on a set of benchmarks, and compare our algorithm with previous work. Experiments show that our algorithm VAP Opt has an average of 61.2% energy saving compared with previous work.

Our contributions are listed as the following: 1) Our algorithm VAP_Opt gives the optimal solution and achieves significant energy saving compared to previous algorithm. 2) Algorithm VAP_Opt not only is optimal, but also provides more choices of smaller expected total energy consumption with guaranteed confidence probabilities satisfying timing constraints. In many situations, previous algorithm cannot find a solution, while VAP_Opt can find satisfactory results. 3) Algorithm VAP_Opt is practical and quick.

### SUMMARY OF THE INVENTION

Our target is to solve the VAP (voltage assignment with probability) problem which defined as follows: Given M different voltage levels: R₁, R₂, . . . , R_{M}, a PDFG (Probability Data Flow Graph) G=<V.E>, where V is node set and E is edge set, with time T, probability P, and energy consumption C for each node executed on each voltage Rᵢ, a timing constraint L and a confidence probability P, find the voltage for each node in assignment that gives the minimum expected total energy consumption C with confidence probability P under timing constraint L.

To solve the VAP problem, we use dynamic programming method traveling the graph in a bottom up fashion. Thus, the complexity of the algorithm VAP_Opt is O(|V|*L*M*K), where |V| is the number of nodes and L is the given timing constraint. Usually, the execution time of each node is upper-bounded by a constant. In this case, VAP_Opt is polynomial. Note that if L is not upper bounded, this problem is NP-hard which can be proved by 0-1 Knapsack problem. In practice, when the timing constraint is polynomial to the size of PDFG, the running time of our algorithm is very small and our experiments are always finished in very short time.

### BRIEF DESCRIPTION OF THE DRAWINGS

FIG. 1 (a) An Input PDFG. (b) The times, probabilities, and energy consumptions of its node. (c) The scheduling graph.

FIG. 2 The Minimum Total Energy Consumption Under Various Timing Constraints For Voltera Filter.

FIG. 3 The impact of timing constraints on energy consumption.

### DETAILED DESCRIPTION OF THE INVENTION

Architecture

System Model: Probabilistic Data-Flow Graph (PDFG) is used to model a DSP application. A PDFG G=<V, E, T, R> is a directed acyclic graph (DAG), where V is the set of nodes; R is a voltage set; the execution time T is a random variable; E is the edge set that defines the precedence relations among nodes in V. There is a timing constraint L and it must be satisfied for executing the whole PDFG.

Energy Model: Dynamic power, which is the dominant source of power dissipation in CMOS circuit, is proportional to N×Cₐₚ×V_{dd}², where N represent the number of computation cycles for a node, Cₐₚ is the effective switched capacitance, and V_{dd} is the supply voltage. Reducing the supply voltage can result in substantial power and energy saving. Roughly speaking, system's power dissipation is halved if we reduce V_{dd} by 30% without changing any other system parameters. However, this saving comes at the cost of reduced throughput, slower system clock frequency, or higher cycle period time (gate delay). The cycle period time T_{c} is proportional to V_{dd}/(V_{dd}−Vₜₕ)^{a}, where Vₜₕ is the threshold voltage and aε( 1.0, 2.0] is a technology dependent constant.

Let T represent the execution time of a node and C stand for energy consumption Given the number of cycles N of node v, the supply voltage V_{dd} and the threshold voltage Vₜₕ, its computation time T and the energy C for node v are calculated as follows:
T_{c}=k×V_{dd}/(V_{dd}−Vₜₕ)^{a} (1)
T=N×T_{c}=N×k×V_{dd}/(V_{dd}−Vₜₕ)^{a} (2)
C=N×Cₐₚ×V_{dd}² (3)

In Equation (1), k is a device related parameter. From Equations (2) and (3), we can see that the lower voltage will prolong the execution time of a node but reduces its energy consumption. We assume that there is no energy or delay penalty associated with voltage switching.

In our model, under the same voltage (R), the execution time (T) of a task is a random variable, which is usually due to condition instructions or operations that could have different execution times for different inputs. The number of computation cycles (N) for a task is proportional to the execution time. The energy consumption (C) depends on not only the voltage level R, but also the number of computation cycles N. We use the expected value of energy consumption (Exp(C)) as the energy consumption C under a certain voltage level R. Under different voltage levels, a task has different expected energy consumptions. The higher the voltage level is, the faster the execution time is, and the more expected energy is consumed. This paper shows how to assign a proper voltage level to each node of a Probabilistic Data-Flow Graph (PDFG) such that the expected total energy consumption is minimized while satisfying the timing constraint with a guaranteed confidence probability.

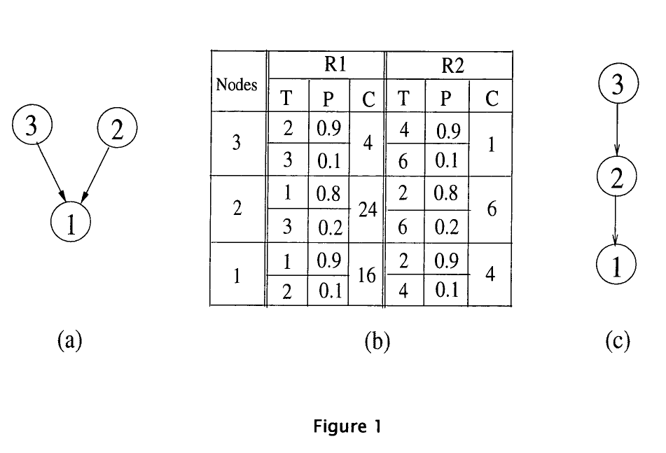

An exemplary PDFG is shown in FIG. 1(a). Each node can select one of the two different voltage levels: R₁ and R₂. The execution times (T), corresponding probabilities (P), and energy consumption (C) of each node under different voltage levels are shown in FIG. 1(b). The execution time T of each node is modeled as a random variable. For example, when choosing R₁, node 1 will be finished in 1 time unit with probability 0.9 and will be finished in 2 time units with probability 0.1. FIG. 1(c) shows an example schedule on uni-processor.

Basic Concepts and Data Structures

To solve the VAP problem, we use dynamic programming method traveling the graph in a bottom up fashion. For the easiness of explanation, we will index the nodes based on bottom up sequence. For example, FIG. 1 (c) shows nodes indexed in a bottom up sequence, that is, v1->v2->v3.

Given the timing constraint L, a PDFG G, and an assignment A, we first give several definitions as follows:

1) Gⁱ: The sub-graph rooted at node vᵢ, containing all the nodes reached by node vᵢ. In our algorithm, each step will add one node which becomes the root of its sub-graph. For example, G³ is the graph containing nodes 1, 2, and 3 in FIG. 1(a).

2) In our algorithm, table D_{i,j} will be built. Each entry of table D_{i,j} will store a link list of (Probability, Consumption) pairs sorted by probability in an ascending order. Here we define the (Probability, Consumption) pair (P_{i,j}, C_{i,j}) as follows: C_{i,j} is the minimum energy consumption of C_{A}(Gⁱ) computed by all assignments A satisfying T_{A}(Gⁱ)≦j with probability≧P_{i,j}.

We introduce the operator “⊕” in this paper. For two (Probability, Consumption) pairs H₁ and H₂, if H₁ is (P_{i,j}¹, C_{i,j}¹), and H₂ is (P_{i,j}², C_{i,j}²), then after applying the ⊕ operation between H₁ and H₂, we get pair (P′, C′), where P′=P_{i,j}¹*P_{i,j}² and C′=C_{i,j}¹+C_{i,j}². We denote this operation as “H₁⊕H₂”.

D_{i,j} is the table in which each entry has a link list that stores pair (P_{i,j}, C_{i,j}) sorted by P_{i,j} in an ascending order. Here, i represents a node number, and j represents time. For example, a link list can be (0.1, 2)->(0.3, 3)->(0.8, 6)->(1.0, 12). Usually, there are redundant pairs in a link list. We use Lemma 1 to cancel redundant pairs.

Lemma 1: Given (P_{i,j}¹, C_{i,j}¹) and (P_{i,j}², C_{i,j}²) in the same list:

1) If P_{i,j}¹=P_{i,j}², then the pair with minimum C_{i,j} is selected to be kept.

2) If P_{i,j}¹<P_{i,j}² and C_{i,j}¹≧C_{i,j}², then C_{i,j}² is selected to be kept.

In every step of our algorithm, one more node will be included for consideration. The information of this node is stored in local table E_{i,j}, which is similar to table D_{i,j}, but with accumulative probabilities only on node vᵢ. A local table only store information, such as probabilities and consumptions, of a node itself. Table E_{i,j} is the local table only storing the information of node vᵢ. In more detail, E_{i,j} is a local table of link lists that store pair (p_{i,j}, c_{i,j}) sorted by p_{i,j} in an ascending order; c_{i,j} is the energy consumption only for node vᵢ with timing constraint j, and p_{i,j} is CDF (cumulative distributive function) F(j).

Algorithm

In this section, the algorithms of our approach are presented.

Algorithm: Optimal algorithm for the VAP problem (VAP_Opt)

Input: M different types of voltages, a scheduling graph, and the timing constraint L.

Output: An optimal voltage assignment.

1) Build local table Eᵢⱼ for each node of PDFG.

| 2) | 1: let D₁ⱼ = E₁ⱼ | |
|---|---|---|
| | 2: for each node vᵢ, i> 1 do | |
| | 3: | for each time j do |

| | |
|---|---|
| 4: | for each time k in E_{i,k} do |

| | |
|---|---|
| 5: | if Dᵢ₋₁ⱼ₋ₖ != = NULL then |

| | |
|---|---|
| 6: | Dᵢⱼ = = D_{i-1 j-k} ⊕ E_{i,k} |

| | |
|---|---|
| 7: | else |

| | |
|---|---|
| 8: | continue |

| | |
|---|---|
| 9: | end if |

| | |
|---|---|
| 10: | end for |
| 11: | insert Dᵢⱼ₋₁ to Dᵢⱼ and remove redundant pairs using |
| | Lemma 1 |

| | |
|---|---|
| 12: | end for |

13: end for

3) return D_{Nj}

Algorithm VAP_Opt first builds a local table E_{i,j} for each node. Next, in step 2 when i=1, G¹ has only one node. We set D_{1,j}=E_{1,j}. Then using dynamic programming method, we build the table D_{i,j}. For each node vᵢ under each time j, we try all the times k (1≦k≦j) in table E_{i,j}. We use “⊕” on the two tables D_{i-1,j-k} and E_{i,k}. Since k+(j−k)=j, the total time of nodes from v₁ to vᵢ is j. The “⊕” operation adds the energy consumptions of two tables together and multiply the probabilities of two tables with each other. Finally, we use Lemma 1 to remove the redundant pairs. The new energy consumption in each pair obtained in table D_{i,j} is the energy consumption of current node vᵢ at time k plus the energy consumption in each pair obtained in D_{i-1,j-k}. Since we have used Lemma 1 to cancel redundant pairs, the energy consumption of each pair in D_{i,j} is the minimum expected total energy consumption for graph Gⁱ with confidence probability P_{i,j} under timing constraint j.

Theorem 1: For each pair (P_{i,j}, C_{i,j}) in D_{i,j} (1≦i≦N) obtained by algorithm VAP_Opt, C_{i,j} is the minimum total energy consumption for graph Gⁱ with confidence probability P_{i,j} under timing constraint j.

Proof: By induction. Basic Step: When i=1, there is only one node, so it is true. Induction Step: In step 2 of the algorithm, we try all the possible. Then we use operator to add the energy consumptions of two tables and multiply the probabilities of two tables. Finally, redundant pair will be removed by using Lemma 1. The new energy consumption in each pair obtained in table D_{i+1,j} is the energy consumption of current node vᵢ₊₁ at time k plus the energy consumption in each pair obtained in D_{i,j-k}. Thus, Theorem 1 is true for any i (1≦i≦N).

It is clear any execution sequence will generate the same D_{N,j}.

Theorem 2: Given a PDFG, for any legal uni-processor scheduling, the final D_{N,j} will be the same.

Experiments

We present the experimental results of our algorithms. We conduct experiments on a set of benchmarks including 4-stage lattice filter, 8-stage lattice filter, voltera filter, differential equation solver, RLS-languerre lattice filter, and elliptic filter. Among them, the PDFG for first three filters are trees and those for the others are DAGs. Three different voltage levels, R₁, R₂, and R₃, are used in the experiment, in which the node is executed quickest with the highest energy consumption under R₁ and is executed slowest with the lowest energy consumption under R₃. The execution times, probabilities, and energy consumptions for each node are randomly assigned. The experiments are performed on a Dell PC with a P4 2.1 G processor and 512 MB memory running Red Hat Linux 7.3.

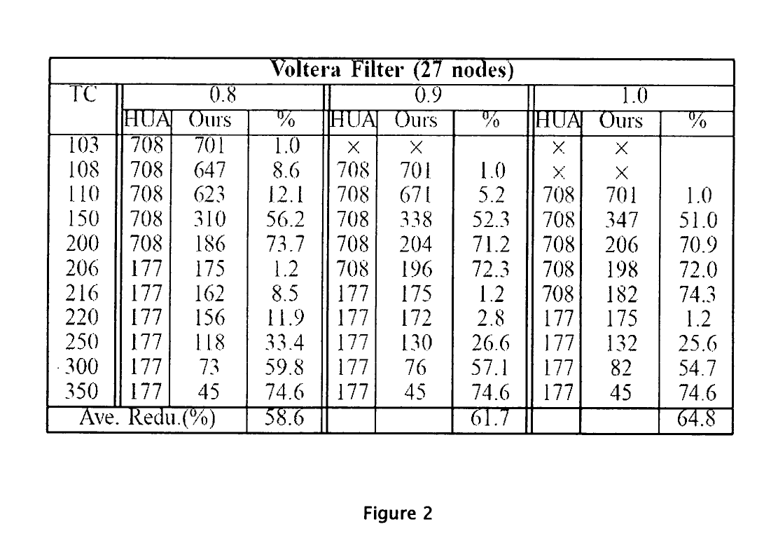

The experimental results for voltera filter are shown in FIG. 2, which are finished in less than one second. In these experiments, we compare our algorithm with the heuristic algorithm HUA of Hua et al. from University of Maryland. In each table, column “TC” represents the given timing and “Ours” represents our optimal algorithm VAP_Opt. The minimum total energy consumption obtained from different algorithms: VAP_Opt and the heuristic HUA, are presented in each entry. Columns “1.0”, “0.9”, and “0.8”, represent that the confidence probability is 1.0, 0.9, and 0.8, respectively. Column “%” shows the percentage of reduction on the total energy consumption, compared with the results of algorithm HUA. The average percentage reduction is shown in the last row “Ave. Redu. (%)” of FIG. 2. An entry with “_” means no solution available. From the FIG. 2, we found in many situations, algorithm VAP_Opt has significant energy consumption reduction than algorithm HUA. For example, in FIG. 2, under the timing constraint 200, for probability 0.8, the entry under “HUA” is 708. The entry under “Ours” is 186, which means by using VAP_Opt algorithm, we can achieve minimum total energy consumption 186 with confidence probability 0.8 under timing constraint 100, and the energy reduction is 73.7%. On average, algorithm VAP_Opt gives an energy consumption reduction of 64.1% with 1.0 confidence probability, and energy consumption reductions of 61.4% and 58.0% with 0.9 and 0.8 confidence probabilities respectively. Compared with HUA, the expected total average energy consumption improvement of our algorithm VAP_Opt is 61.2%.

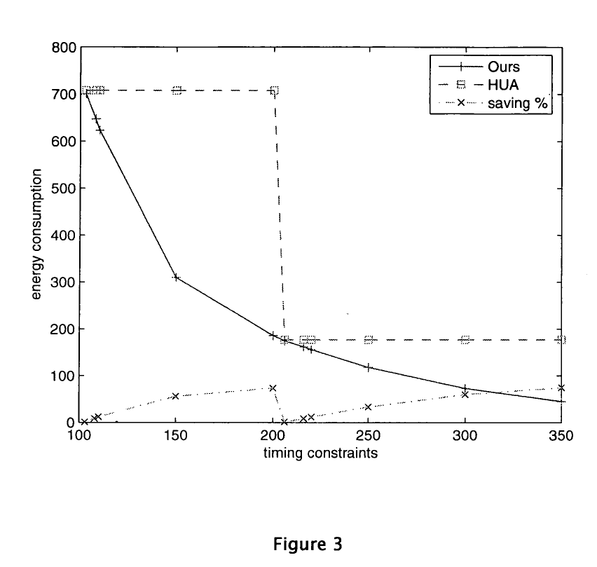

FIG. 3 depicts the impact of timing constraints on energy consumption for voltera filter. We fixed the guaranteed probability as 0.80. The solid line with “+” stands for the results from algorithm VAP_Opt. The dashed line stands for the results from algorithm HUA. The dot dashed line with “_” is the result curve of energy saving percentage of algorithm VAP_Opt to HUA. This shows the design space exploration can be well explored by using our optimal algorithm.

What is claimed is:

1. A novel optimal algorithm, VAP_Opt, to minimize expected value of total energy consumption while satisfying timing constraints with guaranteed probabilities for real-time applications.

2. Based on the algorithm, two theorems have been given:
Theorem 1: For each pair (P_{i,j}, C_{i,j}) in D_{i,j} (1≦i≦N) obtained by algorithm VAP_Opt, C_{i,j} is the minimum total energy consumption for graph Gⁱ with confidence probability P_{i,j} under timing constraint j;
Theorem 2: Given a PDFG, for any legal uni-processor scheduling, the final D_{N,j} will be the same.
